(19) United States
(12) Patent Application Publication
(10) Pub. No.: US 2022/0228872 A1
(43) Pub. Date: Jul. 21, 2022

(54) APPARATUS AND METHOD FOR GENERATING ROAD MAP

(71) Applicants: Hyundai Motor Company, Seoul (KR); Kia Corporation, Seoul (KR)

(72) Inventor: Chi Hwan Kim, Seongnam (KR)

(21) Appl. No.: 17/528,487

(22) Filed: Nov. 17, 2021

(30) Foreign Application Priority Data
Jan. 21, 2021 (KR) 10-2021-0008546

(51) Int. Cl. G01C 21/32; G01C 21/36; G01C 21/34

(52) U.S. Cl. CPC G01C 21/32; G01C 21/3492; G01C 21/3484; G01C 21/367

(57) ABSTRACT

An apparatus and method for generating a map based on driving information are provided. The apparatus includes a user log analyzing device that clusters a user based on a driving tendency of the user by analyzing a user log, in which driving information of a user vehicle is recorded. A reliability calculating device calculates reliability for each driving situation of the user based on a driving tendency of a user cluster and a map generating device generates a map by extracting a map change point based on the calculated reliability.

### CROSS-REFERENCE TO RELATED APPLICATION

This application claims the benefit of priority to Korean Patent Application No. 10-2021-0008546, filed on Jan. 21, 2021, the entire contents of which are incorporated herein by reference.

### TECHNICAL FIELD

The present disclosure relates to an apparatus and method for generating a map based on driving information.

### BACKGROUND

In general, a map system provides a map image, which is obtained by partially synthesizing images captured by a specific person while the specific person walks around a specific area, into the entire map image. However, since people need to capture pictures for map collection while walking around, this is cumbersome work. For this reason, it is impossible to update a map image frequently.

To solve the issues, the map is generated and updated using an image, which is obtained from a camera of a user's vehicle while the vehicle is driven, or the driving trajectory of the user's vehicle. Accordingly, there is no need to go around for the purpose of collecting maps. However, inaccurate or different information may be provided depending on the user's driving habit and driving tendency. For example, information collected from the user's vehicle that is driven illegally may be reflected to the generation of a map. Accordingly, the reliability of the generated map may be deteriorated.

### SUMMARY

The present disclosure has been made to solve the above-mentioned problems occurring in the prior art while advantages achieved by the prior art are maintained intact. An aspect of the present disclosure provides an apparatus and method for generating a map based on driving information that automatically generates a map using a user's driving information collected while a vehicle is driven, thereby more easily building a map, to which an actual road situation is reflected.

Furthermore, an aspect of the present disclosure provides an apparatus and method for generating a map based on driving information that determines reliability for each driving situation depending on a user's driving tendency, extracts a change point of a road based on driving information having high reliability, and generates a map, thereby improving the accuracy of map generation.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a driving information-based map generating apparatus may include a user log analyzing device configured to cluster a user based on a driving tendency of the user by analyzing a user log in which driving information of a user vehicle is recorded, a reliability calculating device configured to calculate reliability for each driving situation of the user based on a driving tendency of a user cluster, and a map generating device configured to generate a map by extracting a map change point based on the calculated reliability.

The user log may include lane change information of the user vehicle and driving information not matched with a road map. The lane change information may include one or more of a link id of a point where a lane is changed, lane change time, the number of lane changes, the number of times that rapid acceleration/deceleration occurs, or the number of times that a turn signal is manipulated. The driving information not matched with the road map includes one or more of turn information, U-turn information, or one-way entry information.

The user log analyzing device determines whether the user is illegally driving, by analyzing information about driving, which is not matched with a road map, from the user log. The user log analyzing device determines a driving habit of the user by analyzing the lane change information from the user log. The user log analyzing device may be configured to classify a user cluster type based on a driving tendency and selects a user cluster type, which has a driving tendency similar to the driving tendency of the user, to be clustered. The user log analyzing device clusters the user based on identification information of the user stored in a user DB and a driving habit of the user.

The identification information of the user includes one or more of a seat position, a rear view mirror position, or fuel efficiency information for respective road grade or traffic information situation. The reliability calculating device may be configured to identify the driving tendency of the user cluster, classify each driving situation of the user vehicle, and calculate reliability for each driving situation based on the driving tendency of the user cluster.

According to an aspect of the present disclosure, a driving information-based map generating method may include clustering a user based on a driving tendency of the user by analyzing a user log, in which driving information of a user vehicle is recorded, calculating reliability for each driving situation of the user based on a driving tendency of a user cluster, and generating the map by extracting a map change point based on the calculated reliability.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a configuration of an apparatus for generating a map based on driving information, according to an embodiment of the present disclosure;

FIG. 2 is a diagram used to describe an operation of a driving information collecting device, according to an embodiment of the present disclosure;

FIG. 3 is a diagram illustrating an embodiment of a user log, according to an embodiment of the present disclosure;

FIGS. 4, 5A and 5B are diagrams illustrating an embodiment of a user clustering operation, according to an embodiment of the present disclosure;

FIGS. 6, 7, and 8 are flowcharts illustrating an operation flow of a method of generating a map based on driving information, according to an embodiment of the present disclosure; and

FIG. 9 is a diagram illustrating a computing system performing a method, according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

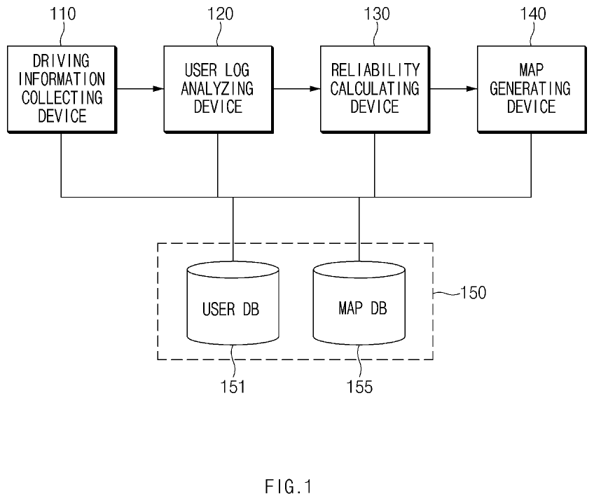

FIG. 1 is a diagram illustrating a configuration of an apparatus for generating a map based on driving information, according to an embodiment of the present disclosure. Referring to FIG. 1, an apparatus for generating a map based on driving information according to an embodiment of the present disclosure may include a driving information collecting device 110, a user log analyzing device 120, a reliability calculating device 130, a map generating device 140, and a DB 150. Herein, the driving information collecting device 110, the user log analyzing device 120, the reliability calculating device 130, or the map generating device 140 according to an embodiment of the present disclosure may be implemented with one or more processors.

First of all, the DB 150 may include a user DB 151 and a map DB 155. The user DB 151 and the map DB 155 may be implemented as separate components. The user DB 151 may be configured to store unique information for recognizing a user. For example, the user DB 151 may be configured to store the user's seat position, the user's rear view mirror position, a road grade, and/or fuel efficiency information for each traffic situation.

In addition, the user DB 151 may be configured to store driving log information of the user collected while a vehicle is driven. Herein, the driving log information may include lane change information such as the number of lane changes, the number of times that rapid acceleration/deceleration occurs, and the number of times that a turn signal is manipulated, and may include driving information that is not matched with a conventional road map. The map DB 155 may be configured to store map data of a road network built in advance. The map DB 155 may be configured to additionally store the road map generated by the map generating device 140.

FIG. 1 illustrates that the user DB 151 and the map DB 155 are included in the vehicle-based map generating apparatus. However, according to an embodiment, the user DB 151 and the map DB 155 may be implemented as separate DBs that are not included in the vehicle-based map generating apparatus. In particular, the driving information-based map generating apparatus may be configured to access the user DB 151 and/or the map DB 155 to obtain or store predetermined information.

The driving information collecting device 110 may be configured to collect road information and driving situation information that occurs based on the user's intent while a vehicle is driven. Herein, the driving situation information may include information about the manipulation of a brake, an accelerator, a steering wheel, and a turn signal, which occurs depending on the user's intent, or driving information such as acceleration/deceleration caused by the manipulation. In addition, the road information may include information about a road around a vehicle being driven, road information on the user's driving route, and the like.

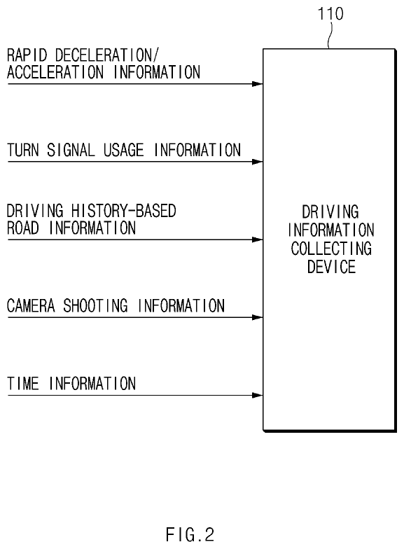

The detailed operation of the driving information collecting device 110 will be described in more detail with reference to FIG. 2. Retelling to FIG. 2, the driving information collecting device 110 may be configured to collect information (e.g., rapid deceleration/acceleration information, turn signal usage information, or the like) generated by a user's manipulation while a vehicle being driven.

Additionally, the driving information collecting device 110 may be configured to collect road information based on the user's driving history. For example, the road information may include line information such as a solid line, a dotted line, a center line, or the like, information about the number of lanes, road type information such as way in/out, a turn section, a U-turn section, or the like, or information about presence/absence of surrounding surveillance cameras, traffic conditions, or the like. In addition, the driving information collecting device 110 may be configured to collect information about a road, on which the user's vehicle is frequently driven, based on the user's driving history.

Furthermore, the driving information collecting device 110 may be configured to collect information captured by a camera while the vehicle is driven, time information, and the like. In particular, the driving information collecting device 110 may be configured to collect driving information in real time, or may be configured to collect the driving information at a predetermined period. In Addition, whenever a preset collection condition is satisfied (e.g., when the set driving information is changed), the driving information collecting device 110 may be configured to collect the related driving information.

The driving information collecting device 110 may be configured to collect driving information from a plurality of sensors provided in the vehicle. Meanwhile, the driving information collecting device 110 may include one or more sensors for detecting respective driving information. The driving information collected by the driving information collecting device 110 may be stored in the user DB 151. The user log analyzing device 120 may be configured to call and analyze the user log stored in the user DB 151.

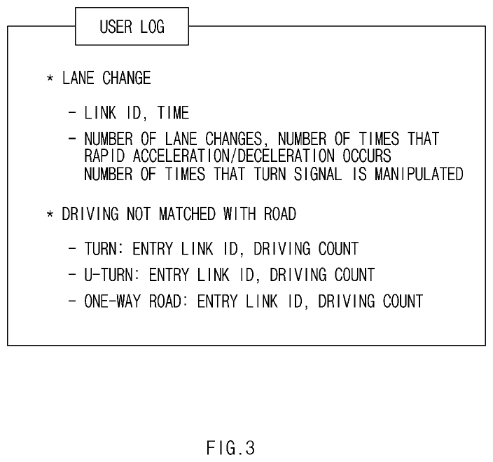

Particularly, an embodiment of a user log stored in the user DB 151 will be described with reference to FIG. 3. Referring to FIG. 3, lane change information while a vehicle is driven may be recorded in the user log. At this time, the lane change information may include a link identification (id) of a point where a lane is changed, lane change time, the number of lane changes, the number of times that rapid acceleration/deceleration occurs, the number of times that a turn signal is manipulated, and the like. At this time, the user log analyzing device 120 may be configured to analyze a user's driving habit by comparing a road condition at a point, at which a lane change occurs, with the lane change information recorded in the user log.

Moreover, information about the user's driving that is not matched with a road map may be recorded in the user log. For example, information associated with a case of driving not in accordance with the regulations of the road (e.g., a case that a vehicle makes a turn on a road that is not within a turning section, a case that a vehicle makes a U-turn on a road where a U-turn is not allowed, or a case that a vehicle enters a one-way road in an opposite direction) may be recorded in the user log.

In addition, the user log may be configured to record driving information at a point at which a detailed road map is not present. Accordingly, the user log analyzing device 120 may be configured to determine whether the user is illegally driving, by analyzing the information about driving that is not matched with the road map from the user log.

Herein, the user log analyzing device 120 may be configured to determine whether there is illegal driving, by matching the actual the map DB 155 based on information for each driving situation and detailed information such as a link id, link attribute information, road grade, or the like at a point at which a vehicle is driven to not be matched with a road. Meanwhile, the user log analyzing device 120 may be configured to determine whether there is illegal driving, by comparing information about the average driving of the entire cluster with information about the user's driving. Accordingly, the user log analyzing device 120 may be configured to identify the user's driving habit and whether the user is illegally driving, by analyzing the user log, and may classify the user's driving tendency based on the identified result. At this time, the user log analyzing device 120 may be configured to cluster users depending on the driving tendency of the classified users.

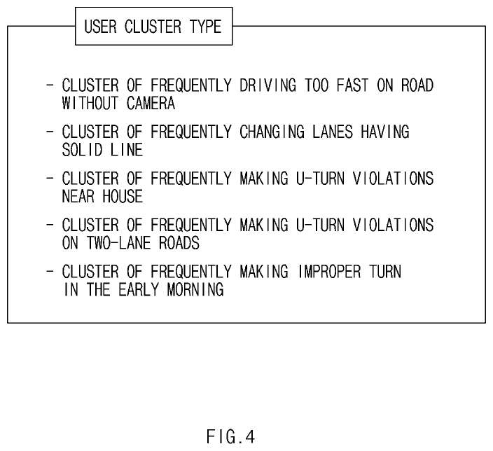

An embodiment of a user cluster type will be described with reference to FIG. 4. Referring to FIG. 4, user cluster types may be classified depending on a user's driving tendency. For example, the user cluster types may be classified into a cluster of frequently driving too fast on a road without a camera, a cluster of frequently changing lanes having a solid line, a cluster of frequently making U-turn violations near a house (or a road on which a user is driving frequently), a cluster of frequently making an improper turn in the early morning, or the like.

In addition, the user cluster types may be classified based on the user's driving tendency according to driving situations. Accordingly, the user log analyzing device 120 may be configured to cluster the corresponding user into a cluster type, which corresponds to the user's driving tendency, from among a plurality of user cluster types.

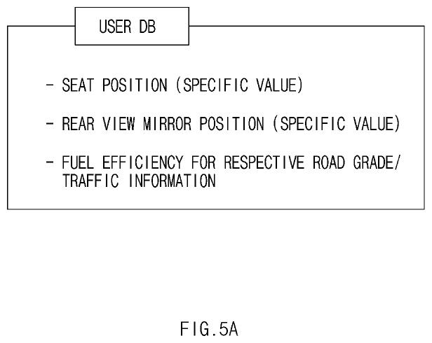

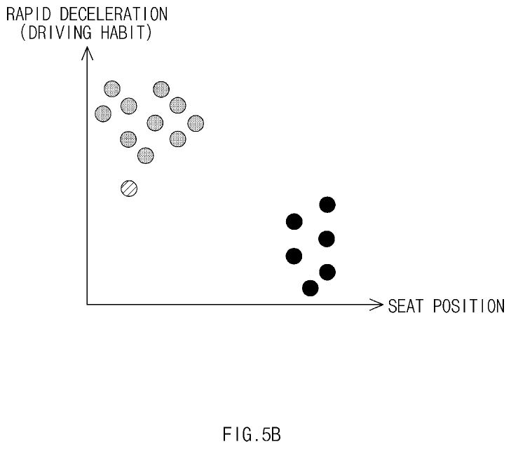

In the meantime, the user log analyzing device 120 may also be configured to classify the user cluster types through the cluster based on the user's identification information stored in the user DB 151 and the user's driving habit. For example, as illustrated in FIG. 5A, when user identification information such as a seat position, a rear view mirror position, a road grade, and/or fuel efficiency information for each traffic situation is stored in the user DB 151, the user log analyzing device 120 may be configured to classify user cluster types as shown in FIG. 5B, by clustering driving habits of users based on the user identification information stored in the user DB 151 of FIG. 5A.

In particular, when the user's seat position, the user's rear view mirror position, or fuel efficiency information for respective road grade/traffic information and the driver's driving habit are matched with or similar to the pre-classified user cluster type, the user log analyzing device 120 may be configured to cluster users into the corresponding cluster type. The reliability calculating device 130 may be configured to identify the driving habit for each situation of the cluster selected as the user log analyzing device 120 clusters users, and then calculate reliability for each driving situation of a user based on the identified result.

For example, the reliability calculating device 130 may be configured to calculate reliability for each driving situation by applying a low-reliability criterion to a driving situation, in which there is illegal driving, in a selected cluster. In the meantime, the reliability calculating device 130 may be configured to calculate reliability for each driving situation by applying a high-reliability criterion to a driving situation, in which road traffic laws are observed, in the selected cluster.

Herein, the reliability calculating device 130 may be configured to assign a reliability score to each driving situation based on the reliability calculation result. In the meantime, the reliability calculating device 130 may be configured to assign, to each driving situation, a first value, which is greater than a reference value, or a second value, which is less than the reference value, depending on the result of calculating the reliability. Accordingly, a method in which the reliability calculating device 130 assigns the reliability depending on each driving situation may be applied in various manners.

Herein, when the user's driving is not matched with a road in a driving situation where the reliability of a user cluster is greater than a reference value, an actual road condition is different from the road condition on the map. Accordingly, the map generating device 140 may be configured to generate a map based on the reliability for each driving situation. At this time, the map generating device 140 may be configured to generate a map based on high reliability (i.e., a driving situation with reliability that is not less than the reference value).

For example, assuming that the selected user cluster is compliant with laws in a situation in which a vehicle is turning, a user's vehicle may inevitably make a turn on a general road due to road construction, or the like. In particular, the turning driving situation of the user cluster has high reliability, and thus it may be determined that a road map at the corresponding location is incorrect. Accordingly, the map generating device 140 may be configured to generate a road map at a point, at which the turning driving situation occurs, unlike the map and then store the generated road map in the map DB 155.

Accordingly, the driving information-based map generating apparatus according to an embodiment of the present disclosure may be configured to generate a map based on the user's highly reliable driving situation. Therefore, information about a road not shown on the map may be generated more easily, and information about a road at a point where a road situation has changed may be updated more easily. The driving information-based map generating apparatus 100 according to an embodiment of the present disclosure operating as described above may be implemented in the form of an independent hardware device or controller including a memory and a processor for processing each operation and may be driven in the form included in other hardware devices such as a microprocessor.

In the meantime, although not illustrated in FIG. 1, the driving information-based map generating apparatus according to an embodiment of the present disclosure may further include at least one of an interface and a communication device. The interface may include an input for receiving a control command from a user and an output for outputting the operating state, result, or the like of the driving information-based map generating apparatus 100.

Herein, the input may include a key button and may include a soft key implemented on a display. In addition, the input may include a mouse, a joystick, a jog shuttle, a stylus pen, and the like. The output may include a display and may include a voice output such as a speaker. At this time, when a touch sensor such as a touch film, a touch sheet, or a touch pad is included in the display, the display may be configured to operate as a touch screen and may be implemented in the form in which the input and the output are integrated with each other.

Herein, the display may include at least one of a liquid crystal display (LCD), a thin film transistor-liquid crystal display (TFT-LCD), an organic light-emitting diode (OLED) display, a flexible display, a field emission display (FED), or a 3D display. The communication device may include a communication module for vehicle network communication with automotive components and/or controllers included in a vehicle. Herein, the technology of the vehicle network communication may include Controller Area Network (CAN) communication, Local Interconnect Network (LIN) communication, Flex-Ray communication, or the like.

Moreover, the communication device may include a communication module for wireless Internet access or a communication module for short range communication. Herein, the wireless Internet technology may include Wireless LAN (WLAN), Wireless Broadband (Wibro), Wi-Fi, World Interoperability for Microwave Access (Wimax), or the like. Also, the technology of the short range communication may include Bluetooth, ZigBee, Ultra Wideband (UWB), Radio Frequency Identification (RFID), Infrared Data Association (IrDA), or the like.

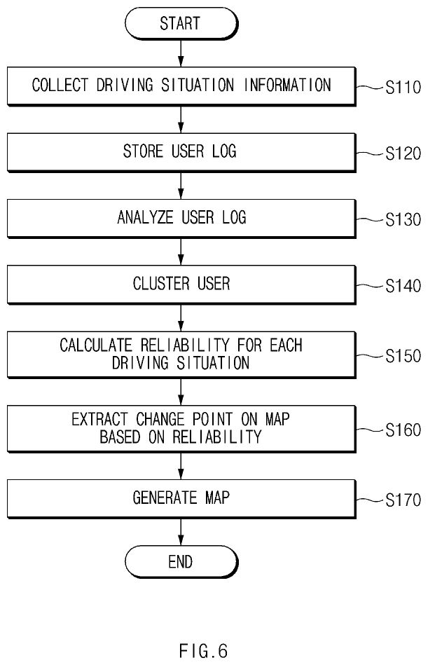

The operation flow of the apparatus according to an embodiment of the present disclosure will be described in more detail as follows. The method described herein below may be executed by a controller. FIGS. 6, 7, and 8 are flowcharts illustrating an operation flow of a method of generating a map based on driving information, according to an embodiment of the present disclosure.

First of all, referring to FIG. 6, a map generating apparatus may be configured to collect driving information of a user's vehicle (S110). Herein, the map generating apparatus may be configured to collect information about frequently-driven road, information captured by a camera and time information based on information about sudden deceleration/acceleration, information about usage of a turn signal, and a user's driving history. The map generating apparatus may be configured to store the driving information collected in operation S110 in the user log (S120). An embodiment of a user log will be described with reference to FIG. 3. Afterward, the map generating apparatus may be configured to identify the user's driving tendency by analyzing the user log stored in operation S120 and then cluster the user based on the analyzed result.

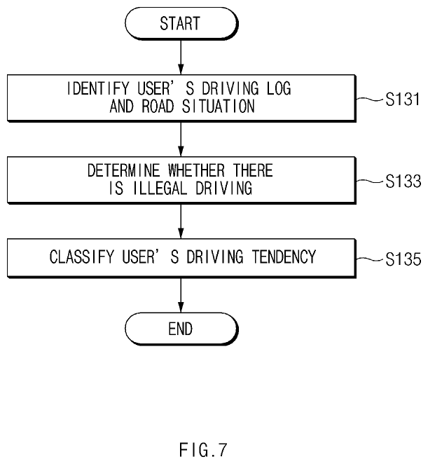

Herein, the detailed operation of a user log analysis process will be described with reference to FIG. 7. Referring to FIG. 7, the map generating apparatus may be configured to identify a user's driving log and a road situation of a map (S131), and then determine whether there is illegal driving, based on the identified result in operation S131 (S133).

The map generating apparatus may be configured to classify the user's driving tendency based on the user's driving habit identified in operation S131 and operation S133 and whether there is illegal driving in a predetermined driving situation (S135). At this time, the map generating apparatus may be configured to select a cluster similar to the user's driving tendency classified in operation S135 among user cluster types and then cluster the user (S140). The map generating apparatus may be configured to calculate reliability for each user's driving situation based on the driving tendency of the user cluster selected in operation S140 (S150).

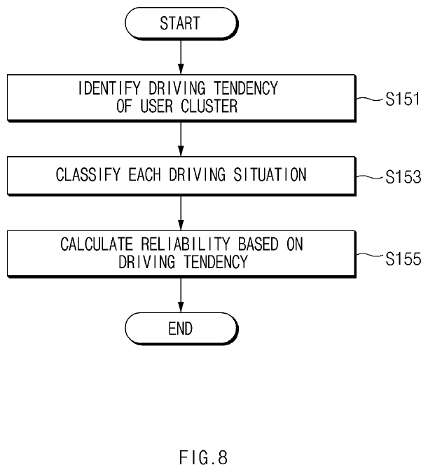

Herein, the detailed operation of a user log analysis process will be described with reference to FIG. 8. Referring to FIG. 8, a map generating apparatus may be configured to identify the driving tendency of a user cluster selected in operation S140 (S151), and classify a driving situation of each user (S153). Afterward, the map generating apparatus may be configured to calculate reliability for each driving situation classified in operation S153, based on the driving tendency of the user cluster identified in operation S151 (S155).

The map generating apparatus may be configured to extract a change point on a map based on the reliability for each driving situation calculated in operation S155 (S160), and then generate a map based on the change point extracted in operation S160 (S170). The generated map may be stored in the map DB 155 and may be used for road driving later.

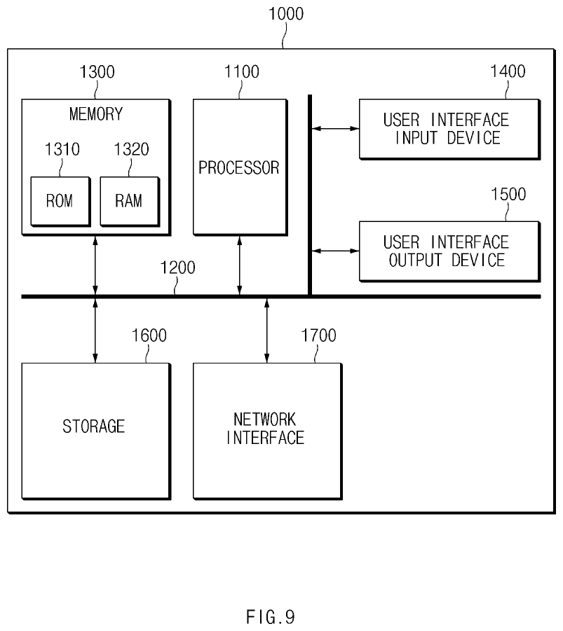

FIG. 9 is a diagram illustrating a computing system performing a method, according to an embodiment of the present disclosure. Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

According to an embodiment of the present disclosure, it is possible to automatically generate a map by using a user's driving information collected while a vehicle is driven, thereby more easily building a map, to which an actual road situation is reflected. Furthermore, according to an embodiment of the present disclosure, it is possible to determine reliability for each driving situation depending on a user's driving tendency, to extract a change point of a road based on driving information having high reliability, and to generate a map, thereby improving the accuracy of map generation.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A driving information-based map generating apparatus, the apparatus comprising:
a user log analyzing device configured to cluster a user based on a driving tendency of the user by analyzing a user log, in which driving information of a user vehicle is recorded;
a reliability calculating device configured to calculate reliability for each driving situation of the user based on a driving tendency of a user cluster; and
a map generating device configured to generate a map by extracting a map change point based on the calculated reliability.

2. The apparatus of claim 1, wherein the user log includes lane change information of the user vehicle and driving information not matched with a road map.

3. The apparatus of claim 2, wherein the lane change information includes one or more of a link id of a point where a lane is changed, lane change time, the number of lane changes, the number of times that rapid acceleration/deceleration occurs, or the number of times that a turn signal is manipulated.

4. The apparatus of claim 2, wherein the driving information not matched with the road map includes one or more of turn information, U-turn information, or one-way entry information.

5. The apparatus of claim 2, wherein the user log analyzing device is configured to determine whether the user is illegally driving, by analyzing information about driving, which is not matched with a road map, from the user log.

6. The apparatus of claim 2, wherein the user log analyzing device is configured to determine a driving habit of the user by analyzing the lane change information from the user log.

7. The apparatus of claim 6, wherein the user log analyzing device is configured to classify a user cluster type depending on a driving tendency and select a user cluster type, which has a driving tendency similar to the driving tendency of the user, to be clustered.

8. The apparatus of claim 1, wherein the user log analyzing device is configured to cluster the user based on identification information of the user stored in a user database (DB) and a driving habit of the user.

9. The apparatus of claim 8, wherein the identification information of the user includes one or more of a seat position, a rear view mirror position, or fuel efficiency information for respective road grade or traffic information situation.

10. The apparatus of claim 1, wherein the reliability calculating device is configured to identify the driving tendency of the user cluster, classify each driving situation of the user vehicle, and calculate reliability for each driving situation based on the driving tendency of the user cluster.

11. The apparatus of claim 10, wherein the reliability calculating device is configured to calculate the reliability by applying a low-reliability criterion to a driving situation in which a driving tendency of the user cluster corresponds to illegal driving.

12. The apparatus of claim 1, wherein the map generating device is configured to extract a map change point based on a driving situation corresponding to reliability of a predetermined reference value or more.

13. A method for generating a map based on driving information, the method comprising:
clustering, by a controller, a user based on a driving tendency of the user by analyzing a user log, in which driving information of a user vehicle is recorded;
calculating, by the controller, reliability for each driving situation of the user based on a driving tendency of a user cluster; and
generating, by the controller, the map by extracting a map change point based on the calculated reliability.

14. The method of claim 13, wherein the user log includes lane change information including one or more of a link id of a point where a lane is changed, lane change time, the number of lane changes, the number of times that rapid acceleration/deceleration occurs, or the number of times that a turn signal is manipulated, and driving information not matched with a road map.

15. The method of claim 14, wherein the driving information not matched with the road map includes one or more of turn information, U-turn information, or one-way entry information.

16. The method of claim 14, wherein the clustering of the user includes:
determining, by the controller, a driving habit of the user and whether the user is illegally driving, by analyzing the lane change information and the driving information not matched with the road map from the user log; and
classifying, by the controller, a driving tendency depending on the driving habit of the user and whether the user is illegally driving.

17. The method of claim 13, wherein the clustering of the user includes:
classifying, by the controller, a user cluster type depending on a driving tendency; and
selecting, by the controller, a user cluster type, which has a driving tendency similar to the driving tendency of the user, to be clustered.

18. The method of claim 13, wherein the clustering of the user includes:
clustering, by the controller, the user based on identification information including one or more of a seat position, a rear view mirror position, or fuel efficiency information for respective road grade or traffic information situation, which is stored in a user database (DB), and a driving habit of the user.

19. The method of claim 13, wherein the calculating of the reliability includes:
identifying, by the controller, the driving tendency of the user cluster;
classifying, by the controller, each driving situation of the user vehicle; and
calculating, by the controller, reliability for each driving situation based on the driving tendency of the user cluster.

20. The method of claim 13, wherein the calculating of the reliability includes:
calculating, by the controller, the reliability by applying a low-reliability criterion to a driving situation in which a driving tendency of the user cluster corresponds to illegal driving.
